(19) United States
(12) Patent Application Publication
(10) Pub. No.: US 2024/0059934 A1
(43) Pub. Date: Feb. 22, 2024

(54) PRESSURE-SENSITIVE ADHESIVE COMPOSITION

(71) Applicant: LG CHEM, LTD., Seoul (KR)

(72) Inventors: Seung Yeon RYU, Daejeon (KR); Hyun Cheol KIM, Daejeon (KR); Yeon Keun LEE, Daejeon (KR); Ji Young KIM, Daejeon (KR)

(73) Assignee: LG CHEM, LTD., Seoul (KR)

(21) Appl. No.: 18/258,667

(22) PCT Filed: Apr. 15, 2022
(86) PCT No.: PCT/KR2022/005111

§ 371 Date: Jun. 21, 2023

(30) Foreign Application Priority Data
Apr. 15, 2021 (KR) 10-2021-0049148

(51) Int. Cl. C09J 7/38; C09J 133/06

(52) U.S. Cl. CPC C09J 7/385; C09J 133/06; C09J 2301/302; C09J 2301/408; C09J 2301/312

(57) ABSTRACT

A pressure-sensitive adhesive composition for forming a pressure-sensitive adhesive layer, which is applied to a flexible device, thereby effectively responding to repeated deformation and recovery, causing no defects (for example, observation of deformation traces and the like) before and after deformation, having excellent cuttability and workability, causing no lifting, delamination, and/or bubble generation, and exhibiting a transmittance at a level capable of omitting a polarizing plate is provided.

### TECHNICAL FIELD

This application is a 35 U.S.C. 371 National Phase Entry Application from PCT/KR2022/005111 filed on Apr. 15, 2022, which claims priority based on Korean Patent Application No. 10-2021-0049148 filed on Apr. 15, 2021, the disclosures of which are incorporated herein by reference in their entirety.

The present application relates to a pressure-sensitive adhesive composition.

### BACKGROUND

A flexible device is a new conceptual device. In an example of the flexible device, a so-called foldable device or rollable device is included.

The pressure-sensitive adhesive layer applied to the foldable device is repeatedly folded and then unfolded, or wound and then unwound.

Therefore, the layer applied to the foldable device is required to be capable of effectively following the repeated deformation, and recovering to its original shape when the force applied during the deformation disappears.

In general, it is known that the lower the elastic modulus of the pressure-sensitive adhesive, particularly, the lower the elastic modulus at a low temperature, the more effectively it is to follow the repeated deformation as above.

However, when the elastic modulus of the pressure-sensitive adhesive layer is too low, there are problems that the property of recovering when the force applied for deformation disappears is deteriorated, and the cuttability and workability are deteriorated.

Therefore, in consideration of cuttability or workability, it may be preferable that the pressure-sensitive adhesive layer has an elastic modulus of a certain level or more, but it is not easy to obtain a pressure-sensitive adhesive layer that effectively follows deformation while securing the desired level of recovery properties, cuttability and workability, and the like.

In addition, when the elastic modulus is increased in consideration of cuttability or workability, there is a problem that the peel force basically required for the pressure-sensitive adhesive layer is lowered.

Therefore, it is an uneasy task to provide a pressure-sensitive adhesive layer having physical properties suitable for a flexible device.

In addition, the pressure-sensitive adhesive, which is usually called OCA (Optically Clear Adhesive) or OCR (Optically Clear Resin), has a high transmittance for light, but the transmittance of the pressure-sensitive adhesive layer for light is adjusted to be relatively low, whereby a technique capable of removing a polarizing plate included for preventing reflection or securing visibility depending on the type of the device is known.

In order to adjust the transmittance of the pressure-sensitive adhesive layer, a dye or the like is generally included in the pressure-sensitive adhesive layer, but the dye thus included affects viscoelastic properties of the pressure-sensitive adhesive layer.

Therefore, it is an uneasy task to secure the elastic modulus, recovery rate, and peel force characteristics of the pressure-sensitive adhesive layer required in the flexible device in a state where the transmittance is adjusted to a level capable of omitting the polarizing plate included in the device.

### BRIEF SUMMARY

The present application relates to a pressure-sensitive adhesive composition. It is one object of the present application to provide a pressure-sensitive adhesive composition suitable for a foldable device.

In one example, it is one object of the present application to provide a pressure-sensitive adhesive layer simultaneously exhibiting a low elastic modulus and an excellent recovery rate suitable for a foldable device, while exhibiting a transmittance at a level capable of omitting a polarizing plate usually included for securing visibility or preventing reflection.

It is an object of the present application to provide a pressure-sensitive adhesive composition for forming a pressure-sensitive adhesive layer, which is applied to a flexible device, thereby effectively responding to repeated deformation and recovery, causing no defects (for example, observation of deformation traces and the like) before and after deformation, having excellent cuttability and workability, and causing no lifting, delamination, and/or bubble generation.

It is also an object of the present application to provide a flexible device to which the pressure-sensitive adhesive composition is applied.

### DETAILED DESCRIPTION

Among the physical properties mentioned in this specification, when the measured temperature affects the relevant physical property, the physical property is a physical property measured at room temperature, unless otherwise specified.

In this specification, the term room temperature is a temperature in a state where it is not particularly warmed and cooled, which may mean any one temperature within the range of about 10° C. to 30° C., for example, a temperature of about 27° C. or less while being about 15° C. or more, 18° C. or more, 20° C. or more, or about 23° C. or more. In addition, unless otherwise specified, the unit of temperature mentioned in this specification is ° C.

Among the physical properties mentioned in this specification, when the measured pressure affects the relevant physical property, the physical property is a physical property measured at normal pressure, unless otherwise specified.

In this specification, the term normal pressure is a pressure in a state where it is not particularly pressurized and depressurized, which usually means a pressure of about 1 atmosphere or so, which is the atmospheric pressure level.

Among the physical properties mentioned in this specification, when the measured humidity affects the relevant physical property, the physical property is a physical property measured at natural humidity in the state of the room temperature and normal pressure, unless otherwise specified.

The present application relates to a pressure-sensitive adhesive composition. When the pressure-sensitive adhesive composition of the present application is cross-linkable (e.g., when it comprises a cross-linkable polymer), the pressure-sensitive adhesive composition may be in a state before cross-linking or a state after cross-linking. In addition, the pressure-sensitive adhesive composition in the cross-linked state may be referred to as a pressure-sensitive adhesive or pressure-sensitive adhesive layer herein.

The storage elastic modulus, recovery rate, creep strain rate and peel force of the pressure-sensitive adhesive composition mentioned in this specification are the storage elastic modulus, recovery rate, creep strain rate and peel force in a state where the pressure-sensitive adhesive composition has been cross-linked, which may thus be the storage elastic modulus, recovery rate, creep strain rate and peel force of the pressure-sensitive adhesive or pressure-sensitive adhesive layer.

The pressure-sensitive adhesive composition of the present application may exhibit a low storage elastic modulus at a low temperature. As such, the pressure-sensitive adhesive composition exhibiting a low storage elastic modulus at a low temperature can effectively follow the repetitive deformation and recovery occurring in the flexible device.

For example, the pressure-sensitive adhesive composition may have a storage elastic modulus at −20° C. of 250,000 Pa or less. In another example, the storage elastic modulus of the pressure-sensitive adhesive composition at −20° C. may also be 240,000 Pa or less, 230,000 Pa or less, 220,000 Pa or less, 210,000 Pa or less, 200,000 Pa or less, 190,000 Pa or less, 180,000 Pa or less, 170,000 Pa or less, 160,000 Pa or less, 150,000 Pa or less, 140,000 Pa or less, 130,000 Pa or less, 120,000 Pa or less, 110,000 Pa or less, 100,000 Pa or less, 98,000 Pa or less, 96,000 Pa or less, 94,000 Pa or less, 92,000 Pa or less, 90,000 Pa or less, 88,000 Pa or less, 86,000 Pa or less, 84,000 Pa or less, 82,000 Pa or less, 80,000 Pa or less, 78,000 Pa or less, 76,000 Pa or less, 74,000 Pa or less, 72,000 Pa or less, 70,000 Pa or less, 68,000 Pa or less, 66,000 Pa or less, 64,000 Pa or less, 62,000 Pa or less, 60,000 Pa or less, 58,000 Pa or less, 56,000 Pa or less, or 54,000 Pa or less or so. The lower limit of the storage elastic modulus at −20° C. is not particularly limited, which may be, for example, 40,000 Pa or more, 42,000 Pa or more, 44,000 Pa or more, 46,000 Pa or more, 48,000 Pa or more, 50,000 Pa or more, 52,000 Pa or more, 54,000 Pa or more, 56,000 Pa or more, 58,000 Pa or more, 60,000 Pa or more, 62,000 Pa or more, 64,000 Pa or more, 66,000 Pa or more, 68,000 Pa or more, 70,000 Pa or more, 72,000 Pa or more, 74,000 Pa or more, 76,000 Pa or more, 78,000 Pa or more, 80,000 Pa or more, 82,000 Pa or more, 84,000 Pa or more, 86,000 Pa or more, 88,000 Pa or more, 90,000 Pa or more, 92,000 Pa or more, 94,000 Pa or more, 96,000 Pa or more, 98,000 Pa or more, 100,000 Pa or more, 110,000 Pa or more, 120,000 Pa or more, 130,000 Pa or more, 140,000 Pa or more, 150,000 Pa or more, 160,000 Pa or more, 170,000 Pa or more, 180,000 Pa or more, or 190,000 Pa or more or so.

As the pressure-sensitive adhesive layer exhibits the storage elastic modulus in the above range at −20° C., which is a relatively low temperature, it is applied to a flexible device, and thus it is possible to effectively respond to the repeated deformation and recovery.

The pressure-sensitive adhesive layer of the present application may exhibit a relatively good recovery rate while exhibiting a low storage elastic modulus as above at a low temperature. In general, when the storage elastic modulus is low, the recovery rate tends to be low. However, the present application simultaneously exhibits a high recovery rate together with a low storage elastic modulus, and such properties can be secured even in a state where the transmittance is adjusted by the addition of dyes or the like.

For example, the pressure-sensitive adhesive composition may have a recovery rate at −20° C. of 70% or more. In another example, the recovery rate may be 72% or more, 74% or more, 76% or more, 78% or more, 80% or more, 82% or more, or 84% or more or so. The upper limit of the recovery rate is not particularly limited, and for example, the recovery rate may be 100% or less, 98% or less, 96% or less, 94% or less, 92% or less, 90% or less, 88% or less, 86% or less, 84% or less, 82% or less, or 80% or less or so.

Even if the flexible device is very largely deformed and recovered, and such a deformation and recovery are repeated, the pressure-sensitive adhesive composition effectively responds to the deformation and recovery by having a relatively low storage elastic modulus and a relatively high recovery rate as above, and there are no deformation traces after recovery, and the like.

In particular, the pressure-sensitive adhesive composition according to one aspect of the present application may exhibit a relatively low storage elastic modulus and a relatively high recovery rate simultaneously as properties more suitable for the flexible device.

For example, the pressure-sensitive adhesive composition may have a storage elastic modulus at −20° C. of 140,000 Pa or less, and a recovery rate of 70% or more.

At this time, in another example, the storage elastic modulus at −20° C. of the pressure-sensitive adhesive composition may be 130,000 Pa or less, 120,000 Pa or less, 110,000 Pa or less, 100,000 Pa or less, 98,000 Pa or less, 96,000 Pa or less, 94,000 Pa or less, 92,000 Pa or less, 90,000 Pa or less, 88,000 Pa or less, 86,000 Pa or less, 84,000 Pa or less, 82,000 Pa or less, 80,000 Pa or less, 78,000 Pa or less, 76,000 Pa or less, 74,000 Pa or less, 72,000 Pa or less, 70,000 Pa or less, 68,000 Pa or less, 66,000 Pa or less, 64,000 Pa or less, 62,000 Pa or less, 60,000 Pa or less, 58,000 Pa or less, 56,000 Pa or less, or 54,000 Pa or less or so and/or 40,000 Pa or more, 42,000 Pa or more, 44,000 Pa or more, 46,000 Pa or more, 48,000 Pa or more, 50,000 Pa or more, 52,000 Pa or more, 54,000 Pa or more, 56,000 Pa or more, 58,000 Pa or more, 60,000 Pa or more, 62,000 Pa or more, 64,000 Pa or more, 66,000 Pa or more, 68,000 Pa or more, 70,000 Pa or more, 72,000 Pa or more, 74,000 Pa or more, 76,000 Pa or more, 78,000 Pa or more, 80,000 Pa or more, 82,000 Pa or more, 84,000 Pa or more, 86,000 Pa or more, 88,000 Pa or more, 90,000 Pa or more, 92,000 Pa or more, 94,000 Pa or more, 96,000 Pa or more, 98,000 Pa or more, 100,000 Pa or more, 110,000 Pa or more, 120,000 Pa or more, 130,000 Pa or more, 140,000 Pa or more, 150,000 Pa or more, 160,000 Pa or more, 170,000 Pa or more, 180,000 Pa or more, or 190,000 Pa or more or so.

Also, at this time, in another example, the recovery rate at −20° C. of the pressure-sensitive adhesive composition may be 72% or more, 74% or more, 76% or more, 78% or more, 80% or more, 82% or more, or 84% or more or so and/or 100% or less, 98% or less, 96% or less, 94% or less, 92% or less, 90% or less, 88% or less, 86% or less, 84% or less, 82% or less, or 80% or less or so.

The pressure-sensitive adhesive composition of the present application may also exhibit a peel force at a level required in a flexible device.

For example, the peel force of the pressure-sensitive adhesive composition may be 500 gf/inch or more, 550 gf/inch or more, 600 gf/inch or more, 650 gf/inch or more, 700 gf/inch or more, 750 gf/inch or more, 800 gf/inch or more, 850 gf/inch or more, 900 gf/inch or more, 950 gf/inch or more, or 1000 gf/inch or more, or may also be 3000 gf/inch or less, 2800 gf/inch or less, 2600 gf/inch or less, 2400 gf/inch or less, 2200 gf/inch or less, 2000 gf/inch or less, 1800 gf/inch or less, 1600 gf/inch or less, 1400 gf/inch or less, 1200 gf/inch or less, 1100 gf/inch or less, or 1050 gf/inch or less or so.

The peel force is the peel force measured at room temperature (about 25° C.) with respect to the glass, which is the peel force measured with a peel angle of 180 degrees and a peel rate of 0.3 m/min.

The pressure-sensitive adhesive composition of the present application by such a peel force may be applied to a flexible device, thereby effectively responding to repeated deformation and recovery, causing no defects (e.g., observation of deformation traces, etc.) before and after deformation, having excellent cuttability and workability, and causing no lifting, delamination and/or bubble generation.

The pressure-sensitive adhesive composition of the present application may also exhibit a suitable creep strain rate in a flexible device. The larger the creep strain rate, the more effectively it can respond to the deformation, but it is an uneasy task to secure a high creep strain rate and a high recovery rate at the same time, and the high creep strain rate is disadvantageous in cuttability and storage stability, and the like. However, the present application may provide a pressure-sensitive adhesive composition exhibiting the relatively high creep strain rate together with the relatively high recovery rate, and having excellent cuttability and storage stability, and the like.

The pressure-sensitive adhesive composition of the present application may have a creep strain rate at −20° C. of 30% or more or so. In another example, the creep strain rate may also be 32% or more, 34% or more, 36% or more, 38% or more, 40% or more, 42% or more, 44% or more, 46% or more, 48% or more, 50% or more, 52% or more, 54% or more, 56% or more, 58% or more, 60% or more, 62% or more, 64% or more, 66% or more, 68% or more, 70% or more, 72% or more, 74% or more, 76% or more, 78% or more, 80% or more, 82% or more, 84% or more, or 86% or more or so. The upper limit of the creep strain rate is not particularly limited. For example, the creep strain rate may also be 100% or less, 98% or less, 96% or less, 94% or less, 92% or less, 90% or less, 88% or less, 86% or less, 84% or less, 82% or less, 80% or less, 78% or less, 76% or less, 74% or less, 72% or less, 70% or less, 68% or less, 66% or less, 64% or less, 62% or less, 60% or less, 58% or less, 56% or less, or 54% or less or so.

The pressure-sensitive adhesive composition of the present application can maintain the properties suitable for a flexible device as described above, even in a state where the transmittance is adjusted so that it can exhibit a transmittance at a level capable of excluding a polarizing plate usually applied for preventing reflection or improving visibility.

For example, the pressure-sensitive adhesive composition may have a transmittance of about 90% or less or so. The transmittance is an average transmittance measured in a wavelength range of 360 nm to 740 nm, which is a transmittance measured, in a state where the pressure-sensitive adhesive composition is formed as a pressure-sensitive adhesive layer having a thickness of about 25 μm or so, with respect to the thickness direction of the pressure-sensitive adhesive layer. The average transmittance is an average value of the results of measuring transmittances for each wavelength within the wavelength range at intervals of 1 nm. In another example, the transmittance may also be 89% or less, 88% or less, 87% or less, 86% or less, 85% or less, 84% or less, 83% or less, 82% or less, 81% or less, 80% or less, or 79% or less or so and/or 50% or more, 55% or more, 60% or more, 65% or more, 70% or more, 75% or more, 80% or more, or 85% or more or so. The pressure-sensitive adhesive composition exhibiting the transmittance in such a range allows to exclude a polarizing plate used for improving visibility and/or securing antireflection properties in a device.

The pressure-sensitive adhesive composition of the present application may exhibit the above-mentioned transmittance in a state where the above-described storage elastic modulus, peel force, creep strain rate and/or recovery rate is maintained.

Such a pressure-sensitive adhesive composition of the present application may comprise various types of pressure-sensitive adhesive polymers, which may comprise, for example, an acrylic copolymer.

The present application relates to a pressure-sensitive adhesive. The pressure-sensitive adhesive of the present application may comprise an acrylic copolymer.

In this specification, the term copolymer means a resulting product of a polymerization reaction of a monomer mixture.

In this specification, the term acrylic copolymer is a copolymer comprising an acrylic monomer unit as a main component. At this time, the main component means, in the acrylic copolymer, a case where the ratio of the acrylic monomer unit is 55 weight % or more, 60 weight % or more, 65 weight % or more, 70 weight % or more, 75 weight % or more, 80 weight % or more, 85 weight % or more, 90 weight % or more, or 95 weight % or more. There is no particular limitation on the upper limit of the content of the acrylic monomer unit in the acrylic copolymer. For example, the acrylic copolymer may comprise 100 weight % or less of the acrylic monomer unit.

In this specification, the term acrylic monomer means acrylic acid, methacrylic acid, acrylic acid ester or methacrylic acid ester.

In this specification, the term (meth)acryl means acryl or methacryl.

The pressure-sensitive adhesive composition may comprise the acrylic copolymer as the main component. For example, the ratio of the acrylic copolymer in the pressure-sensitive adhesive composition may be 55 weight % or more, 60 weight % or more, 65 weight % or more, 70 weight % or more, 75 weight % or more, 80 weight % or more, 85 weight % or more, 90 weight % or more, 95 weight % or more, 97 weight % or more, or 99 weight % or more or so. There is no particular limitation on the upper limit of the content of the acrylic copolymer in the pressure-sensitive adhesive composition. For example, the acrylic copolymer may be included in the pressure-sensitive adhesive composition in an amount of 100 weight % or less. When the pressure-sensitive adhesive composition comprises a component, such as a solvent or a thinner, that is not included in the final pressure-sensitive adhesive layer, the content of the acrylic copolymer is the content in the pressure-sensitive adhesive composition excluding the component not included in the final pressure-sensitive adhesive layer.

As the acrylic copolymer, for example, a copolymer comprising at least an alkyl (meth)acrylate unit and a polar functional group-containing unit may be used.

As the alkyl (meth)acrylate unit, for example, a unit derived from an alkyl (meth)acrylate having an alkyl group with 1 to 10 carbon atoms may be used. In another example, the alkyl group may be an alkyl group with 2 to 20 carbon atoms, 3 to 10 carbon atoms, 4 to 10 carbon atoms, 4 to 9 carbon atoms, or 4 to 8 carbon atoms. The alkyl group may be linear or branched, which may be substituted or unsubstituted. In one example, the unit may be formed using an alkyl (meth)acrylate having an unsubstituted alkyl group while being linear or branched as the alkyl group.

An example of the alkyl (meth)acrylate may be exemplified by methyl (meth)acrylate, ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, 2-ethylhexyl (meth)acrylate, 2-ethylbutyl (meth)acrylate, isononyl (meth)acrylate, n-octyl (meth)acrylate or isooctyl (meth)acrylate, and the like, but is not limited thereto.

The acrylic copolymer may comprise the alkyl (meth)acrylate unit in a ratio within a range of about 25 to 99 weight %. In another example, the ratio of the alkyl (meth)acrylate unit may be 30 weight % or more, 35 weight % or more, 40 weight % or more, 45 weight % or more, 50 weight % or more, 55 weight % or more, 60 weight % or more, 65 weight % or more, 70 weight % or more, 75 weight % or more, 80 weight % or more, 85 weight % or more, 90 weight % or more, or 95% or more, or may also be 95 weight % or less, 90 weight % or less, 85 weight % or less, 80 weight % or less, 75 weight % or less, 70 weight % or less, 65 weight % or less, 60 weight % or less, 55 weight % or less, 50 weight % or less, 45 weight % or less, 40 weight % or less, or 35 weight % or less or so. Within this range, a desired pressure-sensitive adhesive composition may be effectively formed.

The polar functional group-containing unit is a unit formed of a monomer having a polar functional group. Such a monomer usually comprises a polymerizable group (e.g., a carbon-carbon double bond) and a polar functional group simultaneously.

The monomer having a polar functional group may include a hydroxyl group-containing monomer, a carboxyl group-containing monomer, and a nitrogen-containing monomer, and the like, and in the present application, it is particularly advantageous to apply a hydroxyl group-containing monomer, but is not limited thereto.

The hydroxyl group-containing monomer may include 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 2-hydroxypolyethylene glycol (meth)acrylate, or 2-hydroxypolypropylene glycol (meth)acrylate, and the like; an example of the carboxyl group-containing monomer may include (meth)acrylic acid, 2-(meth)acryloyloxyacetic acid, 3-(meth)acryloyloxypropyl acid, 4-(meth)acryloyloxybutyric acid, acrylic acid dimer, itaconic acid, maleic acid and maleic acid anhydride, and the like; and an example of the nitrogen-containing monomer may include (meth)acrylamide, N-vinyl pyrrolidone, or N-vinyl caprolactam, and the like, without being limited thereto. One or a mixture of two or more of the foregoing may be used.

The polar functional group-containing unit may be included in the acrylic copolymer in a ratio of approximately 1 to 100 parts by weight relative to 100 parts by weight of the alkyl (meth)acrylate unit, and under this ratio, it is possible to stably maintain the durability, tackiness and peel force of the pressure-sensitive adhesive layer. In another example, the polar functional group-containing unit may be included in an amount of 5 parts by weight or more, 10 parts by weight or more, 15 parts by weight or more, 20 parts by weight or more, 25 parts by weight or more, 30 parts by weight or more, 35 parts by weight or more, 40 parts by weight or more, 45 parts by weight or more, or 50 parts by weight or more, or may also be included in an amount of 95 parts by weight or less, 90 parts by weight or less, 85 parts by weight or less, 80 parts by weight or less, 75 parts by weight or less, 70 parts by weight or less, 65 parts by weight or less, 60 parts by weight or less, 55 parts by weight or less, 50 parts by weight or less, 45 parts by weight or less, 40 parts by weight or less, 35 parts by weight or less, 30 parts by weight or less, 25 parts by weight or less, 20 parts by weight or less, 15 parts by weight or less, 10 parts by weight or less, or 5 parts by weight or less, relative to 100 parts by weight of the alkyl (meth)acrylate unit.

In the present application, a specific acrylic copolymer may be applied to form the specific pressure-sensitive adhesive composition. In one example, the copolymer may comprise a unit represented by Formula 1 below in addition to the alkyl (meth)acrylate unit and the polar functional group-containing unit to secure the physical properties. The acrylic copolymer comprising these monomer units is effective in forming a desired pressure-sensitive adhesive composition.

In particular, the acrylic copolymer is formed as a so-called crystalline copolymer under a predetermined ratio of the unit of Formula 1 above and/or the polar functional group-containing unit, or has properties similar to those of the crystalline copolymer. In this specification, the term crystalline copolymer means a copolymer whose melting point is identified in a predetermined range in the DSC (Differential Scanning Calorimeter) measurement method described in Examples of this specification.

The acrylic copolymers are known as amorphous copolymers. However, when the unit of Formula 1 above is present in a predetermined ratio, and in some cases, when the unit of Formula 1 above interacts with the polar functional group present in a predetermined ratio, such a copolymer may exhibit crystallinity, or may exhibit at least properties similar to crystallinity. As such, when a copolymer having crystallinity or exhibiting properties similar to crystallinity is applied, the pressure-sensitive adhesive composition having the above-described properties can be efficiently formed. Therefore, it is possible to effectively form a pressure-sensitive adhesive layer exhibiting the above-described elastic modulus and peel force characteristics through the pressure-sensitive adhesive composition to which such a copolymer is applied.

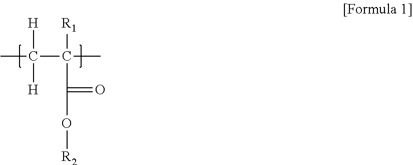

In Formula 1, R₁ represents hydrogen or an alkyl group, and R₂ represents an alkyl group with 11 to 13 carbon atoms.

The unit of Formula 1 is a unit containing a long-chain alkyl group, and such a unit is included in the copolymer in a certain ratio or more, and interacts with a polar functional group as necessary, whereby it is possible to impart crystallinity or properties similar to crystallinity to the copolymer.

In the unit of Formula 1, R₁ may be hydrogen or an alkyl group with 1 to 4 carbon atoms, and may be specifically hydrogen, or a methyl or ethyl group.

In Formula 1, R₂ is an alkyl group with 11 to 13 carbon atoms, where such an alkyl group may be linear or branched, and may be substituted or unsubstituted. In one example, the R₂ may be an unsubstituted alkyl group while being linear. For example, the unit of Formula 1 may be formed using lauryl (meth)acrylate and/or tetradecyl (meth)acrylate, and the like.

When included, the unit of Formula 1 above may be included in the acrylic copolymer in a ratio of approximately 10 to 300 parts by weight relative to 100 parts by weight of the alkyl (meth)acrylate unit. In another example, the ratio of the unit of Formula 1 above may be about 15 parts by weight or more, 20 parts by weight or more, 25 parts by weight or more, 30 parts by weight or more, 35 parts by weight or more, 40 parts by weight or more, 45 parts by weight or more, 50 parts by weight or more, 55 parts by weight or more, 60 parts by weight or more, 65 parts by weight or more, 70 parts by weight or more, 75 parts by weight or more, 80 parts by weight or more, 85 parts by weight or more, 90 parts by weight or more, 95 parts by weight or more, 100 parts by weight or more, 105 parts by weight or more, 110 parts by weight or more, 115 parts by weight or more, 120 parts by weight or more, 125 parts by weight or more, 130 parts by weight or more, 135 parts by weight or more, or 140 parts by weight or more, or may also be 280 parts by weight or less, 260 parts by weight or less, 240 parts by weight or less, 220 parts by weight or less, 200 parts by weight or less, 180 parts by weight or less, 160 parts by weight or less, 140 parts by weight or less, 120 parts by weight or less, 100 parts by weight or less, 90 parts by weight or less, 80 parts by weight or less, 70 parts by weight or less, 65 parts by weight or less, 60 parts by weight or less, 55 parts by weight or less, 50 parts by weight or less, 45 parts by weight or less, 40 parts by weight or less, or 35 parts by weight or less or so, relative to 100 parts by weight of the alkyl (meth)acrylate unit.

The copolymer may further comprise a unit of Formula 2 below as an optional monomer unit, if necessary.

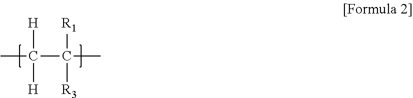

In Formula 2, R₁ represents hydrogen or an alkyl group, and R₃ represents an aromatic ketone group or a (meth)acryloyl group.

The unit of Formula 2 that may be included as an optional monomer unit is a unit comprising an aromatic ketone group or a (meth)acryloyl group in a side chain.

The aromatic ketone group or (meth)acryloyl group in the pressure-sensitive adhesive composition may exist as such, or may also exist in a state after undergoing a hydrogen removal reaction or radical reaction described below.

The aromatic ketone group in the unit of Formula 2 means an aromatic ketone group that induces hydrogen removal (hydrogen abstraction) from a polymer chain when exposed to electromagnetic waves, or a substituent containing such an aromatic ketone group.

When exposed to electromagnetic waves, the aromatic ketone group can remove hydrogen atoms from other polymer chains or from other parts of the polymer chain. This removal results in the formation of radicals, where the radicals can form cross-links between polymer chains or within the same polymer chain. In the category of such aromatic ketone groups, for example, aromatic ketone groups such as derivatives of benzophenone, acetophenone, or anthraquinone are included.

The monomer capable of deriving the unit of Formula 2 having an aromatic ketone group includes 4-benzoylphenyl (meth)acrylate, 4-(meth)acryloyloxyethoxybenzophenone, 4-(meth)acryloyloxy-4′-methoxybenzophenone, 4-(meth)acryloyloxyethoxy-4′-methoxybenzophenone, 4-(meth)acryloyloxy-4′-bromobenzophenone and/or 4-acryloyloxyethoxy-4′-bromobenzophenone, and the like, but is not limited thereto.

The (meth)acryloyl group in the unit of Formula 2 means a (meth)acryloyl group that induces free radical polymerization when exposed to electromagnetic waves in the presence of an appropriate radical initiator, or a substituent comprising the same. Such a (meth)acryloyl group may act similarly to the aromatic ketone group by irradiation with electromagnetic waves.

The unit of Formula 2 in which R₃ is a (meth)acryloyl group, for example, may be formed by preparing a precursor copolymer and then further reacting it with an unsaturated reagent compound to introduce a (meth)acryloyl group. Typically, the introduction of the (meth)acryloyl group involves (1) a reaction between a nucleophilic group on the precursor copolymer and an electrophilic group on the unsaturated reagent compound (i.e., the unsaturated reagent compound contains both an electrophilic group and a (meth)acryloyl group), or (2) a reaction between an electrophilic group on the precursor copolymer and a nucleophilic group on the unsaturated reagent compound (i.e., the unsaturated reagent compound contains both nucleophilic groups and (meth)acryloyl groups). These reactions between nucleophilic groups and electrophilic groups are typically ring opening reactions, addition reactions or condensation reactions.

In this case, the precursor copolymer has a hydroxy, carboxylic acid (—COOH), or anhydride (—O—(CO)—O—) group. When the precursor copolymer has a hydroxyl group, the unsaturated reagent compound often has a carboxylic acid (—COOH), isocyanato (—NCO), epoxy (i.e., oxiranyl) or anhydride group in addition to the (meth)acryloyl group. When the precursor copolymer has a carboxylic acid group, the unsaturated reagent compound often has a hydroxy, amino, epoxy, isocyanato, aziridinyl, azetidinyl or oxazolinyl group in addition to the (meth)acryloyl group. When the precursor (meth)acrylate copolymer has an anhydride group, the unsaturated reagent compound often has a hydroxy or amine group in addition to the (meth)acryloyl group.

In one example, the precursor copolymer may have a carboxylic acid group and the unsaturated reagent compound may have an epoxy group. In an exemplary unsaturated reagent compound, for example, glycidyl (meth)acrylate and 4-hydroxybutyl acrylate glycidyl ether are included. In another example, the precursor copolymer has an anhydride group, and reacts with an unsaturated reagent compound which is a hydroxy-substituted alkyl (meth)acrylate, such as 2-hydroxyethyl (meth)acrylate, 3-hydroxypropyl (meth)acrylate, and the like. In another example, the precursor copolymer has a hydroxy group and the unsaturated reagent compound has an isocyanato group and a (meth)acryloyl group. Such an unsaturated reagent compound comprises an isocyanatoalkyl (meth)acrylate, such as isocyanatoethyl (meth)acrylate, but is not limited thereto.

In one example, the (meth)acryloyl group may be represented by the formula CH₂═CHR¹— (CO)-Q-L- (wherein, L is a linking group and Q is oxy (—O—) or —NH—). Here, L comprises alkylene, arylene, or a combination thereof, and further comprises —O—, —O—(CO)—, —NH—(CO)—, —NH—, or a combination thereof, optionally depending on the precursor copolymer and the specific unsaturated reagent compound, which are reacted to form the (meth)acryloyl group. In some specific examples, the (meth)acryloyl group is H₂C═CHR¹— (CO)—O—R⁶— NH—(CO)—O—R⁵—O—(CO)—, which is formed by a reaction of a hydroxy-containing group of the precursor copolymer represented by the formula —(CO)—O—R⁵-0H and the unsaturated reagent compound which is an isocyanatoalkyl (meth)acrylate represented by the formula H₂C═CHR¹— (CO)—O—R⁶—NCO. Here, R⁵ and R⁶ are each independently an alkylene group, for example, alkylene having 1 to 10 carbon atoms, 1 to 6 carbon atoms, or 1 to 4 carbon atoms. In addition, here, R¹ is methyl or hydrogen.

In the unit of Formula 2, R₁ may be hydrogen or an alkyl group with 1 to 4 carbon atoms, and specifically, may be hydrogen, or a methyl or ethyl group.

The unit of Formula 2, when included, may be included in the acrylic copolymer in a ratio of about 0.001 to 5 parts by weight relative to 100 parts by weight of the alkyl (meth)acrylate unit, and under this ratio, it is possible to effectively form the desired pressure-sensitive adhesive layer by irradiation of electromagnetic waves.

In another example, the ratio of the unit of Formula 2 may be approximately 0.003 parts by weight or more, 0.005 parts by weight or more, 0.007 parts by weight or more, 0.009 parts by weight or more, 0.01 parts by weight or more, 0.015 parts by weight or more, 0.02 parts by weight or more, 0.025 parts by weight or more, 0.03 parts by weight or more, 0.035 parts by weight or more, 0.04 parts by weight or more, 0.045 parts by weight or more, 0.05 parts by weight or more, 0.055 parts by weight or more, 0.06 parts by weight or more, 0.065 parts by weight or more, 0.07 parts by weight or more, 0.075 parts by weight or more, 0.08 parts by weight or more, 0.085 parts by weight or more, 0.09 parts by weight or more, 0.1 parts by weight or more, or may also be 4.5 parts by weight or less, 4 parts by weight or less, 3.5 parts by weight or less, 3 parts by weight or less, 2.5 parts by weight or less, 2 parts by weight or less, 1.5 parts by weight or less, 1 part by weight or less, 0.5 parts by weight or less, 0.3 parts by weight or less, 0.1 parts by weight or less, 0.08 parts by weight or less, 0.06 parts by weight or less, 0.04 parts by weight or less, or 0.02 parts by weight or less or so, relative to 100 parts by weight of the alkyl (meth)acrylate unit, and under this ratio, it is possible to effectively form the desired pressure-sensitive adhesive layer by irradiation of electromagnetic waves.

The acrylic copolymer may appropriately contain other monomer units in addition to the above-described monomer units, as long as the purpose is not impaired (for example, the crystallinity of the copolymer is not impaired).

In one example, the acrylic copolymer included in the pressure-sensitive adhesive layer may be a crystalline acrylic copolymer. As described above, the term crystalline copolymer means a copolymer whose melting point is identified in a predetermined range in the DSC (Differential Scanning Calorimeter) measurement method described in Examples of this specification.

In one example, as the acrylic copolymer, a crystalline acrylic copolymer having a melting point of approximately −20° C. or less or so, which is identified in the above manner, may be used. In another example, the melting point of the crystalline acrylic copolymer may be about −25° C. or less, −30° C. or less, −35° C. or less, or −40° C. or less, or may also be −100° C. or more, −95° C. or more, −90° C. or more, −85° C. or more, −80° C. or more, −75° C. or more, −70° C. or more, −65° C. or more, −60° C. or more, −55° C. or more, −50° C. or more, or −45° C. or more or so. The acrylic copolymer having such a melting point may form the desired pressure-sensitive adhesive layer effectively.

The specific composition of the crystalline acrylic copolymer is not particularly limited. In one example, the crystalline acrylic copolymer may be a copolymer including at least the above-described three types of units (alkyl (meth)acrylate unit, unit of Formula 1, and polar functional group-containing unit). However, all of the above-described acrylic copolymers do not exhibit crystallinity. In order for the acrylic copolymer to exhibit crystallinity, it is necessary to include at least 60 parts by weight or more of the unit of Formula 1 among the above-described units, relative to 100 parts by weight of the alkyl (meth)acrylate unit. In another example, the ratio of the unit of Formula 1 in the crystalline acrylic copolymer may be 65 parts by weight or more, 70 parts by weight or more, 75 parts by weight or more, 80 parts by weight or more, 85 parts by weight or more, 90 parts by weight or more, 95 parts by weight or more, or 100 parts by weight or more, or may also be 300 parts by weight or less, 250 parts by weight or less, 200 parts by weight or less, 150 parts by weight or less, or 100 parts by weight or less or so, relative to 100 parts by weight of the alkyl (meth)acrylate unit.

In the crystalline acrylic copolymer, the ratio (A/B) of the weight (A) of the unit of Formula 1 to the weight (B) of the polar functional group-containing unit may be more than 1.5. In another example, the ratio (A/B) may be 1.7 or more, 1.9 or more, 2.1 or more, 2.3 or more, or 2.5 or more, or may also be 10 or less, 9 or less, 8 or less, 7 or less, 6 or less, 5 or less, 4 or less, 3 or less, 2.5 or less, or 2 or less or so. Also, in the crystalline acrylic copolymer, the polar functional group-containing unit may be a hydroxyl group-containing unit. In one example, a hydroxyalkyl (meth)acrylate having a hydroxyalkyl group with 3 or more, or 4 or more carbon atoms may suitably form the crystalline acrylic copolymer. Although the reason is not clear, it is thought that the interaction between the alkyl group (R₂) of the unit of Formula 1 and the hydroxyalkyl group contributes to the expression of crystallinity of the acrylic copolymer.

In the crystalline acrylic copolymer, the alkyl (meth)acrylate unit may be included in a ratio within the range of about 25 to 65 weight %. In another example, the ratio of the alkyl (meth)acrylate unit may be 30 weight % or more, 35 weight % or more, 40 weight % or more, or 45 weight % or more, or may also be 60 weight % or less, 55 weight % or less, 50 weight % or less, or 45 weight % or less or so. Within this range, it is possible to effectively form the desired pressure-sensitive adhesive layer.

Although the reason is not clear, it is thought that the crystallinity is provided to the acrylic copolymer and the melting point is identified by the interaction or regularity of the respective monomer units contained in the ratio.

As the acrylic copolymer, a copolymer having a weight average molecular weight of 1,000,000 or more may be used. In this specification, the weight average molecular weight means a polystyrene conversion value measured by GPC (gel permeation chromatography).

In one example, the weight average molecular weight may be 1,100,000 or more, 1,200,000 or more, 1,300,000 or more, 1,400,000 or more, 1,500,000 or more, 1,600,000 or more, 1,700,000 or more, 1,800,000 or more, 1,900,000 or more, or 2,000,000 or more, or may also be 5,000,000 or less, 4,000,000 or less, 3,000,000 or less, 2,500,000 or less, or 2,000,000 or less or so. In general, the lower the weight average molecular weight of the copolymer, the greater the change in physical properties after cross-linking, but if the weight average molecular weight is too low, it is disadvantageous in terms of durability under high temperature and/or high humidity conditions. However, in the case of the present application, by using the above-described specific copolymers, it is possible to effectively form the desired pressure-sensitive adhesive layer even in a state where the weight average molecular weight is maintained at an appropriate level.

The pressure-sensitive adhesive composition may further comprise a cross-linking agent. The cross-linking agent may react with the acrylic copolymer to implement a cross-linked structure.

The type of the cross-linking agent is not particularly limited, and for example, a general cross-linking agent such as an isocyanate-based compound, an epoxy-based compound, an aziridine-based compound, and a metal chelate-based compound may be used. This type of cross-linking agent is a so-called thermal cross-linking agent that implements a cross-linked structure by application of heat, and is different from a radical cross-linking agent to be described below. A specific example of the isocyanate-based compound may include one or more selected from the group consisting of tolylene diisocyanate, xylene diisocyanate, diphenylmethane diisocyanate, hexamethylene diisocyanate, isoborone diisocyanate, tetramethylxylene diisocyanate, naphthalene diisocyanate, and a reactant product of any one of the foregoing with a polyol (e.g., trimethylol propane); a specific example of the epoxy-based compound may include one or more selected from the group consisting of ethylene glycol diglycidyl ether, triglycidyl ether, trimethylolpropane triglycidyl ether, N,N,N′,N′-tetraglycidyl ethylenediamine and glycerin diglycidyl ether; and a specific example of the aziridine-based compound may include one or more selected from the group consisting of N,N′-toluene-2,4-bis(1-aziridinecarboxamide), N,N′-diphenylmethane-4,4′-bis(1-aziridinecarboxamide), triethylene melamine, bisisoprotaloyl-1-(2-methylaziridine), and tri-1-aziridinylphosphine oxide, without being limited thereto. In addition, here, a specific example of the metal chelate-based compound may include a compound in which a polyvalent metal such as aluminum, iron, zinc, tin, titanium, antimony, magnesium and/or vanadium is coordinated with acetyl acetone or ethyl acetoacetate, and the like, but is not limited thereto.

In the pressure-sensitive adhesive composition, the cross-linking agent may be included in an amount of 0.0001 to 10 parts by weight relative to 100 parts by weight of the acrylic copolymer. The ratio of the cross-linking agent may be adjusted in consideration of the cohesive force and durability of the pressure-sensitive adhesive layer within the above range. In one example, the ratio of the cross-linking agent may be about 0.0003 parts by weight or more, 0.0005 parts by weight or more, 0.0007 parts by weight or more, 0.0009 parts by weight or more, 0.001 parts by weight or more, 0.002 parts by weight or more, 0.003 parts by weight or more, 0.004 parts by weight or more, 0.005 parts by weight or more, 0.007 parts by weight or more, 0.01 parts by weight or more, 0.02 parts by weight or more, about 0.03 parts by weight or more, about 0.04 parts by weight or more, about 0.05 parts by weight or more, 0.06 parts by weight or more, or about 0.07 parts by weight or more, or may also be about 4 parts by weight or less, about 3 parts by weight or less, about 2 parts by weight or less, about 1 part by weight or less, about 0.8 parts by weight or less, about 0.6 parts by weight or less, about 0.4 parts by weight or less, about 0.2 parts by weight or less, about 0.15 parts by weight or less, about 0.1 parts by weight or less, or about 0.09 parts by weight or less or so.

When the content of the cross-linking agent is selected to cross-link the acrylic copolymer at an appropriate level within the content range, it is possible to effectively form the desired pressure-sensitive adhesive composition.

The pressure-sensitive adhesive composition may comprise, as the cross-linking agent, a so-called radical cross-linking agent which is a cross-linking agent of a different type from the thermal cross-linking agent. Such a cross-linking agent implements a cross-linked structure by radical reaction. Such a radical cross-linking agent may be exemplified by a so-called polyfunctional acrylate, which may include, for example, bifunctional acrylates such as 1,4-butanediol di(meth)acrylate, 1,6-hexanediol di(meth)acrylate, neopentylglycol di(meth)acrylate, polyethylene glycol di(meth)acrylate, neopentyl glycol adipate di(meth)acrylate, hydroxypivalic acid neopentyl glycol di(meth)acrylate, dicyclopentanyl di(meth)acrylate, caprolactone-modified dicyclopentenyl di(meth)acrylate, ethylene oxide-modified di(meth)acrylate, di(meth)acryloxyethyl isocyanurate, allylated cyclohexyl di(meth)acrylate, tricyclodecanedimethanol (meth)acrylate, dimethylol dicyclopentane di(meth)acrylate, ethylene oxide-modified hexahydrophthalic acid di(meth)acrylate, tricyclodecane dimethanol (meth)acrylate, neopentyl glycol-modified trimethylpropane di(meth)acrylate, adamantane di(meth)acrylate or 9,9-bis [4-(2-acryloyloxyethoxy)phenyl]fluorene; trifunctional acrylates such as trimethylolpropane tri(meth)acrylate, dipentaerythritol tri(meth)acrylate, propionic acid-modified dipentaerythritol tri(meth)acrylate, pentaerythritol tri(meth)acrylate, propylene oxide-modified trimethylolpropane tri(meth)acrylate, trifunctional urethane (meth)acrylate, or tris(meth)acryloxyethyl isocyanurate; tetrafunctional acrylates such as diglycerin tetra(meth)acrylate or pentaerythritol tetra(meth)acrylate; pentafunctional acrylates such as propionic acid-modified dipentaerythritol penta(meth)acrylate; and hexafunctional acrylates such as dipentaerythritol hexa(meth)acrylate, caprolactone-modified dipentaerythritol hexa(meth)acrylate or urethane (meth)acrylate (e.g., a reactant product of an isocyanate monomer and trimethylol propane tri(meth)acrylate, etc.), and the like, but is not limited thereto.

The radical cross-linking agent in the pressure-sensitive adhesive composition may also be present in an appropriate ratio depending on the purpose, which may be included, for example, in an amount of 0.01 to 10 parts by weight or 0.01 to 5 parts by weight relative to 100 parts by weight of the acrylic copolymer.

The radical cross-linking agent does not correspond to an essential component.

In addition to the above components, the pressure-sensitive adhesive composition may comprise appropriate additional components as needed, which may also comprise, for example, components of a radical initiator, an ultraviolet absorber, a light stabilizer, a plasticizer, and/or a cross-linking catalyst, and the like.

For example, the pressure-sensitive adhesive composition may comprise a dye or a pigment for desired transmittance adjustment.

Here, the type of the applicable dye or pigment is not particularly limited. That is, in consideration of the desired transmittance and transmittance of the pressure-sensitive adhesive composition in a state where the dye or pigment is not included, an appropriate type of dyes or pigments known in the art may be selected and used.

As the dye or pigment known to be capable of adjusting the transmittance of the pressure-sensitive adhesive composition, for example, azo-based, anthraquinone-based, methine-based, azomethine-based, merocyanine-based, naphthoquinone-based, tetrazine-based, benzo-based, pyromethene-based and/or diketopyrrolopyrrole-based materials, and the like are known.

As the dye or pigment, a dye or pigment having a maximum absorption wavelength within the wavelength range (360 nm to 740 nm) may be used, and two or more types of dyes or pigments may be mixed and used for implementing appropriate transmittances.

The content of the dye may also be selected in an appropriate range so that a desired transmittance may be achieved, if necessary.

The present application also relates to a pressure-sensitive adhesive layer that is a cross-linked product of the pressure-sensitive adhesive composition as above. In the present application, the method of forming the pressure-sensitive adhesive layer by cross-linking is not particularly limited, and an appropriate cross-linking method may be applied in consideration of the type of the applied acrylic copolymer and/or cross-linking agent to form the pressure-sensitive adhesive layer. For example, if the acrylic copolymer and/or cross-linking agent is a type cross-linked by application of heat, a cross-linked product may be formed by applying appropriate heat, and if it is a type cross-linked by irradiation with electromagnetic waves, a cross-linked product may be formed by irradiation with appropriate electromagnetic waves, and other cross-linking methods may also be applied.

Such a pressure-sensitive adhesive layer may exhibit the above-described elastic modulus and/or peel force characteristics.

The thickness of such a pressure-sensitive adhesive layer of the present application is not particularly limited, and it may have a thickness of a conventional pressure-sensitive adhesive layer in consideration of the applied use.

The present application also relates to a pressure-sensitive adhesive film or an optical laminate, which comprises a base film and the pressure-sensitive adhesive layer formed on one or both sides of the base film. In the case of the optical laminate, the base film may be an optical film.

That is, the pressure-sensitive adhesive layer of the present application may be formed on one or both sides of the base film to form a pressure-sensitive adhesive film, or may be formed on one or both sides of the base film, which is an optical film, to form an optical laminate.

At this time, the type of the applicable base film is not particularly limited. As the base film, a base film which is applicable to the formation of the pressure-sensitive adhesive film may be usually applied.

For example, as the base film, a PET (poly(ethylene terephthalate)) film, a PTFE (poly(tetrafluoroethylene)) film, a PP (polypropylene) film, a PE (polyethylene) film, a polyamide film, a COP (cyclic olefin polymer) film, a polybutene film, a polybutadiene film, a vinyl chloride copolymer film, a polyurethane film, an ethylene-vinyl acetate film, an ethylene-propylene copolymer film, an ethylene-ethyl acrylate copolymer film, an ethylene-methyl acrylate copolymer film and/or a polyimide film, and the like may be used, without being limited thereto.

The thickness of the base film is not particularly limited, and it may have an appropriate thickness within a range suitable for the purpose.

When the optical film is applied as the base film, there is no particular limitation on the type of the optical film. In one example, the optical film may be a polarizing film, a polarizing plate, or a retardation film, and the like. Even in this case, the optical film may have a thickness in an appropriate range depending on the purpose.

The pressure-sensitive adhesive film or the optical laminate may further comprise a release film or a protective film for protecting the pressure-sensitive adhesive layer until use, if necessary.

The present application also relates to a flexible device comprising the pressure-sensitive adhesive layer, the pressure-sensitive adhesive film, or the optical laminate. In the device, there is no particular limitation on the application form of the pressure-sensitive adhesive layer, the pressure-sensitive adhesive film, or the optical laminate. For example, the pressure-sensitive adhesive layer may be used for the application of a so-called OCA (Optically Clear Adhesive) or OCR (Optically Clear Resin) in the device, and thus the application form of the pressure-sensitive adhesive layer, the pressure-sensitive adhesive film, or the optical laminate may be the same as the application form of the conventional OCA or OCR.

In this case, in one example, the flexible device may comprise a display panel and the pressure-sensitive adhesive layer, pressure-sensitive adhesive film, or optical laminate present on one or both sides of the display panel. In this case, the display panel may be configured to be folded or rolled through one or more folding shafts or rolling shafts.

Other elements constituting such a flexible device are not particularly limited, where well-known components of the flexible device may be employed without limitation.

However, since the pressure-sensitive adhesive composition exhibits transmittance characteristics in the above-described range, the polarizing plate included in the conventional device for improving visibility and/or preventing reflection may be excluded.

Therefore, the device may not comprise a polarizing plate.

### Advantageous Effects

The present application may provide a pressure-sensitive adhesive composition.

The present application may provide a pressure-sensitive adhesive composition suitable for a foldable device.

In one example, the present application may provide a pressure-sensitive adhesive layer simultaneously exhibiting a low elastic modulus and an excellent recovery rate suitable for a foldable device, while exhibiting a transmittance at a level capable of omitting a polarizing plate usually included for securing visibility or preventing reflection.

The present application may provide a pressure-sensitive adhesive composition for forming a pressure-sensitive adhesive layer, which is applied to a flexible device, thereby effectively responding to repeated deformation and recovery, causing no defects (for example, observation of deformation traces and the like) before and after deformation, having excellent cuttability and workability, and causing no lifting, delamination, and/or bubble generation.

The present application may also provide a flexible device to which the pressure-sensitive adhesive composition is applied.

### BRIEF DESCRIPTION OF DRAWINGS

FIGS. 1 and 2 are views showing the results of identifying the melting point of the acrylic copolymers of Examples 3 and 4, respectively.

FIG. 3 is a graph for measuring a creep strain rate and a recovery rate.

FIG. 4 is a diagram showing a structure of a specimen applied in a dynamic folding test.

FIG. 5 is a diagram showing a process in which a dynamic folding test is performed.

Hereinafter, the present application will be described in detail through Examples, but the scope of the present application is not limited by Examples below.

1. Evaluation of Storage Elastic Modulus

The storage elastic modulus was evaluated using ARES G2 (Advanced Rheometric Expansion System G2) (TA). A specimen was prepared by cutting a pressure-sensitive adhesive layer having a thickness of about 0.8 mm or so into a circle having a diameter of about 8 mm or so. The pressure-sensitive adhesive layer was prepared by overlapping pressure-sensitive adhesive layers having a thickness of about 25 μm or so to have a thickness of about 0.8 mm or so. The storage elastic modulus at the measurement temperature was evaluated for the specimen using a parallel plate fixture having a diameter of about 8 mm. Upon the evaluation, the evaluation conditions were set to a frequency of 1 Hz and a strain of 5%.

2. Creep Strain Rate and Recovery Rate Evaluation

A creep strain rate and a recovery rate were evaluated in the following manner. A specimen was prepared by cutting a pressure-sensitive adhesive layer having a thickness of about 0.8 mm or so into a circle having a diameter of about 8 mm or so. The pressure-sensitive adhesive layer was prepared by overlapping pressure-sensitive adhesive layers having a thickness of about 25 μm or so to have a thickness of about 0.8 mm or so.

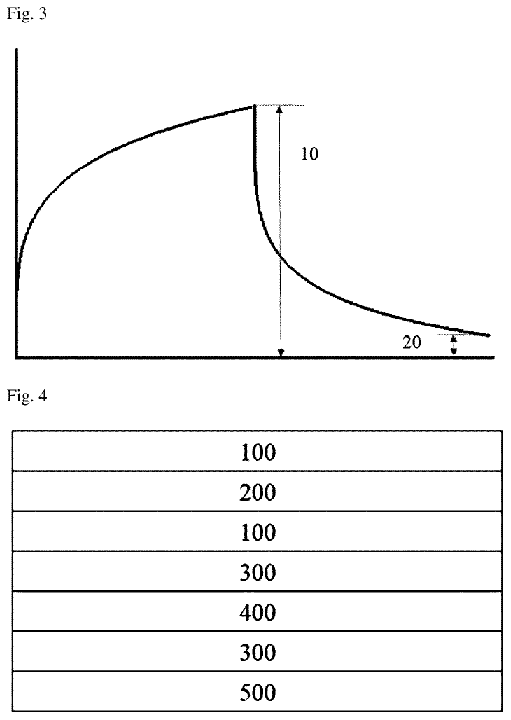

The specimen was mounted on a parallel plate fixture with a diameter of about 8 mm using ARES G2 (Advanced Rheometric Expansion System G2) (TA), and a stress of about 10,000 Pa or so was applied to the specimen in the shear direction for 600 seconds, and the strain rate after removing the stress was identified, as shown in FIG. 3, and evaluated.

In the graph of FIG. 3, the x-axis is an axis showing the lapse of time that the starting time of the applied stress is set to 0 sec, and the y-axis is an axis showing the amount of deformation (strain, %) of the pressure-sensitive adhesive layer, and the amount of deformation is the result calculated according to the following Equation A.

Deformation amount(unit: %)=100×(Lₐ−Lᵢ)/Lᵢ [Equation A]

In Equation A, La is the length (unit: mm) after deformation of the pressure-sensitive adhesive layer in the deformation direction (the direction in which the stress is applied), and Li is the initial thickness (unit: mm) of the pressure-sensitive adhesive layer before deformation.

The maximum deformation amount (10 in FIG. 3) of the pressure-sensitive adhesive layer identified by the above evaluation was designated as the creep strain rate value.

In addition, the recovery rate was designated according to Equation B below.

R %=100×(C−S)/C [Equation B]

In Equation B, R % is the recovery rate, C is the creep strain rate value (maximum strain rate), S is the strain rate of the specimen (e.g., 20 in FIG. 3) at the time that the stress of about 10,000 Pa is applied to the specimen for 600 seconds, and then the stress is removed, and 600 seconds have elapsed again.

3. Peel Force Evaluation

A specimen was prepared by cutting the pressure-sensitive adhesive film to be measured (the structure of the release film/pressure-sensitive adhesive layer/base film) into a rectangle having a width of about 25 mm or so and a length of about 100 mm or so. Subsequently, the release film was peeled off, and the pressure-sensitive adhesive layer was attached to a soda lime glass according to JIS Z 0237 using a roller of 2 kg and left at room temperature for 1 day. Thereafter, the peel force was measured using a TA (Texture Analyzer) instrument (Stable Micro System), while peeling the pressure-sensitive adhesive layer at a peel angle of 180 degrees and a peel rate of 0.3 m/min at room temperature.

4. Melting Point Evaluation

A melting point of a copolymer was measured according to a measurement method using a conventional DSC (Differential Scanning Calorimeter) equipment. As the equipment, DSC-STAR3 equipment (Mettler Toledo) was used. About 10 mg of the sample (copolymer) was sealed in a dedicated pan, and the melting point was measured by setting the warming condition to 10° C./min and identifying endothermic and exothermic heat quantities depending on the temperature.

5. Evaluation of Weight Average Molecular Weight

The weight average molecular weight (Mw) of the copolymer was measured using GPC (Gel Permeation Chromatograph), and the measurement conditions are as follows. When measuring the weight average molecular weight, the measurement results were converted using standard polystyrene (manufactured by Aglient System) to prepare the calibration curve.

<GPC Measurement Conditions>
Measuring instrument: Aglient GPC (Aglient 1200 series, U.S.)
Column: connecting two PL Mixed B
Column temperature: 40° C.
Eluent: THF (tetrahydrofuran)
Flow rate: 1.0 μL/min
Concentration: ˜1 mg/mL (100 μl injection)

6. Dynamic Folding Test

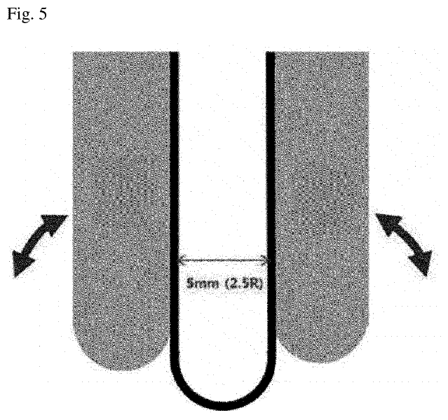

A dynamic folding test was performed by preparing a specimen as shown in FIG. 4. A laminate prepared by sequentially laminating a polyimide film (200) having a thickness of about 50 μm or so in which hard coating layers (100) were formed on both sides, a pressure-sensitive adhesive layer (300), a polarizing plate (400), a pressure-sensitive adhesive layer (300), and a display panel (500) as in the specimen as shown in FIG. 4 was cut into a rectangular shape having a horizontal length of about 7.8 cm and a vertical length of about 17 cm or so to prepare the specimen. Subsequently, as shown in FIG. 5, the folding that the specimen was sandwiched between parallel plates with an interval of 5 mm and folded was repeated 200,000 times at 25° C., and the sample was collected, and then defects such as bubble generation, occurrence of lifting/delamination, occurrence of cracks in the coating layer were visually observed. A case in which even one of the above defects occurred was evaluated as NG, and a case in which all the above defects did not occur was evaluated as PASS.

7. Transmittance Evaluation

A pressure-sensitive adhesive layer having a thickness of about 25 μm or so was formed of a pressure-sensitive adhesive composition in the manner presented in Examples or Comparative Examples, and the transmittances were measured along the thickness direction of the pressure-sensitive adhesive layer. The transmittance was measured using Shimadzu's UV-VIS spectrophotometer (UV-3600 plus). In addition, the measurement wavelength range was in the range of 360 nm to 740 nm. The transmittances within the wavelength range from the wavelength of 360 nm were measured at wavelength intervals of 1 nm, and the average value was taken as the transmittance.

### Preparation Example 1. Preparation of Copolymer (A)

2-ethylhexyl acrylate (2-EHA) and acrylic acid (AA) were introduced to ethyl acetate as a solvent in a reactor in a weight ratio of 98:2 (2-EHA: AA), and about 500 ppm of a radical initiator (2,2′-azobis(4-methoxy-2,4-dimethylvaleronitrile)) was added thereto, and then subjected to polymerization reaction at about 50° C. for 8 hours to prepare a polymerized product (copolymer (A)). The copolymer (polymerized product) (A) had a weight average molecular weight of approximately 2,000,000 or so.

### Preparation Examples 2 to 5. Preparation of Copolymer

Copolymers (polymerized products) were prepared in the same manner as in Preparation Example 1, except that the weight ratios of the applied monomers and the weight average molecular weights of the polymerized products (copolymers) were changed as shown in Table 1 below.

TABLE 1

| | Copolymer | 2-EHA | LA | BA | HBA | AA | Mw (10000) |
|---|---|---|---|---|---|---|---|
| Preparation | A | 98 | | | | 2 | 200 |
| Example 1 | | | | | | | |
| Preparation | B | 6 | 2 | | 2 | | 200 |
| Example 2 | | | | | | | |
| Preparation | C | | 40 | 45 | 15 | | 200 |
| Example 3 | | | | | | | |
| Preparation | D | 4 | 4 | | 2 | | 200 |
| Example 4 | | | | | | | |
| Preparation | E | | | 99 | 1 | | 200 |
| Example 5 | | | | | | | |

2-EHA: 2-ethylhexyl acrylate
LA: lauryl acrylate
HBA: 4-hydroxybutyl acrylate
BA: butyl acrylate

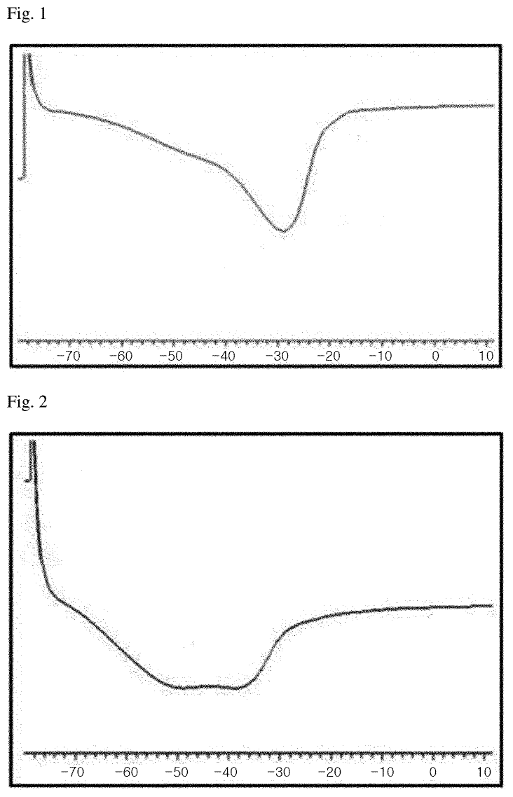

As a result of identifying the melting points of the copolymers of Preparation Examples 1 to 4 among the copolymers of Preparation Examples above, the melting points were identified for the copolymers of Preparation Examples 3 and 4, and the melting point of the copolymer of Preparation Example 3 was identified within the range of approximately −28° C. to −35° C., and the copolymer of Preparation Example 4 exhibited the melting point at a temperature of approximately −44° C. FIGS. 1 and 2 are the melting point identification results for the copolymers of Preparation Examples 3 and 4, respectively.

### Example 1

About 0.035 parts by weight of a cross-linking agent (manufacturer: Samyoung Ink Paint, product name: BXX-5240, 0.03 parts by weight and BXX-5627, 0.005 parts by weight) was compounded relative to 100 parts by weight of the copolymer (polymerized product) (A) of Preparation Example 1, and a dye was further compounded to prepare a pressure-sensitive adhesive composition. As the dye, 0.159 parts by weight of Black 284 from Orient Chemical, 0.0356 parts by weight of Red 335 from BASF, and 0.0755 parts by weight of Yellow 180 from BASF were used.

The pressure-sensitive adhesive composition was applied on a release PET (poly(ethylene terephthalate)) film with a comma coater, and maintained at 130° C. for about 3 minutes or so to form a pressure-sensitive adhesive layer having a thickness of about 25 μm or so.

### Example 2

About 0.07 parts by weight of a cross-linking agent (manufacturer: Asahi Kasei, product name: TKA-100), and a catalyst were compounded relative to 100 parts by weight of the copolymer (polymerized product) (B) of Preparation Example 2, and a dye was further compounded to prepare a pressure-sensitive adhesive composition. As the catalyst, a known catalyst for accelerating the urethane reaction between the isocyanate group and the hydroxyl group was used in a catalytic amount. As the dye, 0.0781 parts by weight of Black 284 from Orient and 0.0119 parts by weight of Yellow 180 from BASF were used.

The pressure-sensitive adhesive composition was applied on a release PET (poly(ethylene terephthalate)) film with a comma coater, and maintained at 130° C. for about 3 minutes or so to form a pressure-sensitive adhesive layer having a thickness of about 25 μm or so.

### Example 3

About 0.07 parts by weight of a cross-linking agent (manufacturer: Asahi Kasei, product name: TKA-100), and a catalyst were compounded relative to 100 parts by weight of the copolymer (polymerized product) (C) of Preparation Example 3, and a dye was further compounded to prepare a pressure-sensitive adhesive composition. As the catalyst, a known catalyst for accelerating the urethane reaction between the isocyanate group and the hydroxyl group was used in a catalytic amount. As the dye, 0.0781 parts by weight of Black 284 from Orient and 0.0119 parts by weight of Yellow 180 from BASF were used.

The pressure-sensitive adhesive composition was applied on a release PET (poly(ethylene terephthalate) film with a comma coater, and maintained at 130° C. for about 3 minutes or so to form a pressure-sensitive adhesive layer having a thickness of about 25 μm or so.

### Example 4

About 0.07 parts by weight of a cross-linking agent (manufacturer: Asahi Kasei, product name: TKA-100), and a catalyst were compounded relative to 100 parts by weight of the copolymer (polymerized product) (D) of Preparation Example 4, and a dye was further compounded to prepare a pressure-sensitive adhesive composition. As the catalyst, a known catalyst for accelerating the urethane reaction between the isocyanate group and the hydroxyl group was used in a catalytic amount. As the dye, 0.0781 parts by weight of Black 284 from Orient and 0.0119 parts by weight of Yellow 180 from BASF were used.

The pressure-sensitive adhesive composition was applied on a release PET (poly(ethylene terephthalate)) film with a comma coater, and maintained at 130° C. for about 3 minutes or so to form a pressure-sensitive adhesive layer having a thickness of about 25 μm or so.

### Comparative Example 1

About 0.11 parts by weight of a cross-linking agent (manufacturer: Soken, product name: T-39M), and a catalyst were compounded relative to 100 parts by weight of the copolymer (polymerized product) (E) of Preparation Example 5, and a dye was further compounded to prepare a pressure-sensitive adhesive composition. As the catalyst, a known catalyst for accelerating the urethane reaction between the isocyanate group and the hydroxyl group was used in a catalytic amount. As the dye, 0.1188 parts by weight of Black 284 from Orient and 0.37 parts by weight of Yellow 180 from BASF were used.

The pressure-sensitive adhesive composition was applied on a release PET (poly(ethylene terephthalate)) film with a comma coater, and maintained at 130° C. for about 3 minutes or so to form a pressure-sensitive adhesive layer having a thickness of about 25 μm or so.

### Comparative Example 2

A pressure-sensitive adhesive layer was formed in the same manner as in Example 2, except that no dye was applied.

### Evaluation Results

The evaluation results for the pressure-sensitive adhesive compositions of Examples or Comparative Examples above were summarized and described in Table 2 below.

In Table 2 below, the unit of storage elastic modulus is Pa, the units of creep strain rate, recovery rate, and transmittance are %, and the unit of peel force is gf/inch.

TABLE 2

| | | Storage elastic | Creep | Peel force | | | Dynamic |
|---|---|---|---|---|---|---|---|
| | | modulus | strain rate | (Glass, | Recovery rate | Trans- | folding |
| | | (−20° C.) | (−20° C.) | 25° C.) | (−20° C.) | mittance | test |
| Example | 1 | 200,000 | 52 | about 1000 | 85 | 73 | PASS |
| | 2 | 150,000 | 78.6 | about 1000 | 81 | 81 | PASS |
| | 3 | 90,000 | 56.8 | about 1000 | 82 | 81 | PASS |
| | 4 | 120,000 | 87 | about 1000 | 79 | 81 | PASS |
| Comparative | 1 | 230,000 | 19.2 | about 1000 | 91 | 78 | NG |
| Example | 2 | 150,000 | 78.6 | about 1000 | 82 | 92 | PASS |

1. A pressure-sensitive adhesive composition,
wherein the pressure-sensitive adhesive composition has a storage elastic modulus of 250,000 Pa or less at −20° C. in the cross-linked state,
wherein the pressure-sensitive adhesive composition has a creep strain rate of at least 30% at −20° C. in the cross-linked state,
wherein the pressure-sensitive adhesive composition has a recovery rate of at least 70% in the cross-linked state, and
wherein the pressure-sensitive adhesive composition has an average transmittance of 90% or less with respect to light having a wavelength of 360 nm to 740 nm.

2. The pressure-sensitive adhesive composition according to claim 1, wherein the storage elastic modulus at −20° C. is 140,000 Pa or less, and wherein the recovery rate is 70% or more.

3. The pressure-sensitive adhesive composition according to claim 1, wherein the creep strain rate at −20° C. is at least 32%.

4. The pressure-sensitive adhesive composition according to claim 1, wherein the pressure-sensitive adhesive composition has a room-temperature peel force of at least 500 gf/inch with respect to glass.

5. The pressure-sensitive adhesive composition according to claim 1, comprising an acrylic copolymer.

6. The pressure-sensitive adhesive composition according to claim 1, comprising a crystalline acrylic copolymer.

7. The pressure-sensitive adhesive composition according to claim 1, comprising a crystalline acrylic copolymer having a melting point of −20° C. or less.

8. The pressure-sensitive adhesive composition according to claim 5, wherein the acrylic copolymer comprises an alkyl (meth)acrylate unit and a polar functional group-containing unit.

9. The pressure-sensitive adhesive composition according to claim 8, wherein the alkyl (meth)acrylate unit has a linear or branched alkyl group with 1 to 10 carbon atoms.

10. The pressure-sensitive adhesive composition according to claim 8, wherein the acrylic copolymer further comprises a unit of Formula 1 below: 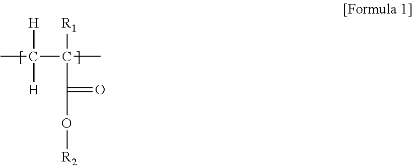
wherein R₁ represents hydrogen or an alkyl group, and R₂ represents an alkyl group with 11 to 13 carbon atoms.

11. The pressure-sensitive adhesive composition according to claim 10, wherein the acrylic copolymer comprises 50 to 300 parts by weight of the unit of Formula 1 relative to 100 parts by weight of the alkyl (meth)acrylate unit.

12. The pressure-sensitive adhesive composition according to claim 11,
wherein the acrylic copolymer comprises the unit of Formula 1 in an amount of 60 parts by weight or more relative to 100 parts by weight of the alkyl (meth)acrylate unit, and
wherein a ratio of a weight (A) of the unit of Formula 1 relative to a weight (B) of the polar functional group-containing unit is at least 1.7, and wherein the polar functional group-containing unit is a unit derived from a hydroxyl group-containing monomer.

13. The pressure-sensitive adhesive composition according to claim 1, comprising a dye.

14. A pressure-sensitive adhesive layer, wherein the pressure-sensitive adhesive layer comprises a cross-linked product of the pressure-sensitive adhesive composition of claim 1.

15. A flexible device, comprising:
a display panel configured to be foldable or rollable through at least one folding axis or at least one rolling axis; and
a pressure-sensitive adhesive layer on one or both sides of the display panel,
wherein the pressure-sensitive adhesive layer comprises a cross-linked product of the pressure-sensitive adhesive composition of claim 1, and
wherein the flexible device doesn't comprise a polarizing plate.
